(19) United States
(12) Patent Application Publication
(10) Pub. No.: US 2007/0101256 A1
(43) Pub. Date: May 3, 2007

(54) Perfect source control

(76) Inventor: Charles Simonyi, Medina, WA (US)

Correspondence Address: PERKINS COIE LLP;PATENT-SEA, P.O. BOX 1247, SEATTLE, WA, 98111-1247, US

(21) Appl. No.: 11/264,364

(22) Filed: Nov. 1, 2005

(51) Int. Cl. G06F 17/00

(52) U.S. Cl. 715/511; 715/530; 715/751

(57) ABSTRACT

A method and system for managing contributions to a document is provided. The contribution management system provides complete information about each individual change, allows retrieving versions of documents that contain only selected changes, and makes it easier to resolve conflicts in changes made by various editors. The contribution management system assigns each element in a document a unique identifier. Editors can modify the document by performing specific editing operations on an identified document element. The contribution management system stores the editor's change as a “contribution” containing the editing operation performed and the unique identifier of the modified element.

### BACKGROUND

Document management systems are commonly used to store documents that can be edited by several editors at the same time. Each editor can check out a document, make changes to it, and check in a new version of the document to the document management system. When several editors make changes to the same document, document management systems generally require that each editor apply those changes to the most up-to-date version of the document in order to check in the changes.

When one editor checks in changes to the document while another editor is making changes to the document, some document management systems attempt to automatically merge the second editor's changes with the new version of the document generated by the other editor so that the second editor's changes can be checked in. If the documents contain text, the merging generally occurs by using common text comparison techniques to determine where text has been added, removed, or modified. Sometimes it is difficult for the document management system to merge the changes of each editor when the changes conflict, such as when one editor deletes a part of the document that another editor makes changes to, or when each editor modifies the same portion of the document. This difficulty is increased because some document management systems cannot even determine how one change may relate to another change. For example, it is difficult to determine the difference between text that has been moved from one location to another and text that has been deleted from one location and then similar new text added to another location. Document management systems often rely on user intervention to resolve conflicts.

Document management systems differ in the level of granularity at which editors can check out documents. For example, a document management system for a book might allow checking out a chapter at a time, or a word processing document management system might allow checking out only an entire document (e.g., file-level granularity) or may allow checking out one paragraph at a time. Regardless of the level of granularity, a potential conflict occurs when two editors check out and modify the same part of a document. If two editors check out the same file, but modify different sections of it, most document management systems are able to determine that no conflict has occurred and allow both editors to check in their changes. When users check out at a fine level of granularity, then the likelihood of a conflict is reduced because editors are less likely to be editing the same checked-out portion of the document.

When a change made by one editor cannot be merged with a change made by another editor, a conflict occurs. Some document management systems handle conflicts by preventing the second editor from checking in the conflicting change. The second editor can then either abandon the change or modify the change so that it does not conflict with the first editor's change. Other document management systems allow the second editor's change to be checked in, either by overwriting the first editor's change or by prompting the editor to create a new branch in the document tree. A branch creates two or more divergent versions of a document that are independently modified in the future such that changes to one are not automatically applied to the others.

One type of document management system is a software source control system that provides a mechanism for several software developers to simultaneously work on a body of source code. The source code files are the documents, and each developer is an editor. It is typically a goal of a source control system that changes are well tracked and that the source code is kept in a state such that it can be built to produce a working executable file. When many developers are working simultaneously on the same source code, conflicts often arise and it is important both to know which developer made each change so that they can be contacted to fix any problems and to be able to produce a version of the source code that will still build correctly after conflicting changes have been made (e.g., by not applying the conflicting change or by alerting an operator that manual resolution of a conflict is required).

Document management systems typically consist of a server component and a client component. The server component generally maintains a database containing each document and a record of the changes (e.g., history of check-ins) made to each document. The server also maintains a record of which editors have checked in which documents, so that this information can be used to perform any required merge when a new change is checked in. The client component generally consists of software to contact the server to check in and check out files, as well as an editor used to modify the files.

To achieve their goals, many current document management systems store a complete version of the document each time a check-in is made, and allow retrieving any such versions. For example, if user A checks in a change to a document, and then user B checks in a change to the document, it is generally possible to retrieve a version of the document prior to either change, a version after A's change (original+A), and a version after both A's and B's changes (original+A+B). One problem with these systems is that it is not possible to retrieve versions of the document other than those that existed at the time a document was checked in. For example, if two changes are checked in one after another, it is often possible to retrieve the version of the document after the first change, but not possible to retrieve a version of the document containing the second change without the first change. In the example above, it might be desirable to retrieve a version including only user B's change (original+B) if user A's change is found to have an error.

However, in a typical document management system either a new change that removed A's change would need to be checked in or both A's and B's changes would need to be removed and then B's change reapplied.

Another problem with current document management systems is that detailed information is not available when a conflict occurs so that an operator of the document management system can select among conflicting changes. For example, if an operator looks at the version of the document after user A and user B have made their changes above, it is difficult to separate the two changes and understand what was the purpose of A's change versus the purpose of B's change.

### BRIEF DESCRIPTION OF THE DRAWINGS

FIG. 1 illustrates a layout of the contribution management system in one embodiment.

FIG. 2 illustrates components of the contribution management system server in one embodiment.

FIG. 3 is a block diagram that illustrates the relationship of versions of a document following two changes to the document.

FIG. 4 is a block diagram that illustrates a data structure used by the contribution management system to store contributions in one embodiment.

FIG. 5 is a flow diagram that illustrates the processing of a client checking in a document in one embodiment.

FIG. 6 is a flow diagram that illustrates the processing of the check-out component of the contribution management system server in one embodiment.

FIG. 7 is a flow diagram that illustrates the processing of the check-in component of the contribution management system in one embodiment.

FIGS. 8a and 8b are block diagrams showing the history list in two embodiments.

### DETAILED DESCRIPTION

A method and system for managing contributions to a document is provided. In some embodiments, the contribution management system provides complete information about each individual change, allows retrieving versions of documents that contain only selected changes, and makes it easier to resolve conflicts in changes made by various editors. The contribution management system assigns each element in a document a unique identifier. For example, each character or each word in a text document can be a document element. Editors can modify the document by performing specific editing operations on an identified document element. For example, one editing operation could be deleting an element. The contribution management system stores the editor's change as a “contribution” containing the editing operation performed and the unique identifier of the modified element. For example, a contribution can contain a delete operation and the identifier of the document element that was deleted. Thus, the contribution management system stores only the changes made by the editor, rather than a complete version of the document. For example, if user A and user B make changes to a document, rather than storing the original document including A's changes (original+A), then storing the original document including A's and B's changes (original+A+B), the system stores the original document, user A's change, and user B's change separately. This system makes it possible to retrieve any version of a document simply by selecting which changes are to be applied. For example, if a user requests a version of the document containing only user B's change, then the contribution management system applies user B's changes to the original document to produce the requested version.

In some embodiments, the contribution management system assigns unique identifiers to elements in the document that persist for the lifetime of the document. The use of unique identifiers helps overcome problems of prior text comparison techniques, such as making it easier to differentiate between a situation where text is moved from one location to another and a situation where text is deleted and new text is added. By persisting the unique identifiers for the lifetime of a document, the contribution management system can even detect when a document element that was deleted in one change is revived in a later change. Unique identifiers may be created centrally, such as by a contribution management system server, or they may be generated at each editor's client system, such as by appending a client identification number to a number incremented as elements are created by that client.

In some embodiments, the document elements are nodes in an intentional tree. A system has been described for generating and maintaining a computer program represented as an intentional program tree (for example, U.S. Pat. No. 5,790,863 entitled “Method and System for Generating and Displaying a Computer Program” and U.S. Pat. No. 6,097,888 entitled “Method and System for Reducing an Intentional Program Tree Represented by High-Level Computational Constructs,” which are hereby incorporated by reference). A document storing an intentional tree has inherent organization, and each node of the tree forms a unique identifiable element of the document. Contributions to a document containing an intentional tree can store operations performed on the tree's nodes, such as removing, adding, replacing, or renaming a node.

In some embodiments, the contribution management system stores contributions to a document in a repository accessible to multiple editors. Each editor makes contributions that are checked into the repository, and each editor can access the contributions made by other editors. The contribution management system may also keep a copy of the repository in a local cache on the editor's client computer so that the editor can view files even when disconnected from the repository. Periodically, an editor can instruct the repository to synchronize the locally cached files with the files in the repository. Synchronizing updates the files in the editor's local cache with contributions checked into the repository since the last time the editor synchronized. If the editor has a file checked out that has been changed by another editor, the contribution management system attempts to apply the changes to the local copy and may prompt the editor to resolve any conflicts.

In some embodiments, the repository contains a history list that identifies each contribution and stores supplemental information such as who made the contribution and when it was checked in. The history list can also maintain the resolution to past conflicts in the contribution management system by marking certain contributions as having been removed by an operator. When an editor synchronizes with the repository, only those changes that are not conflicting are typically retrieved. In some embodiments, an editor can also retrieve specified conflicting changes so that these changes can be corrected, or to learn from a prior incorrect change. In some embodiments, the history list contains multiple lists which track divergent versions of a project. For example, in a software source control system, it is often desirable to begin work on a second version of a product while a first version of the product is still being tested prior to being released. The history list can maintain the documents for the two product versions by keeping separate lists that track the progression of changes to each version. In such embodiments, the entries in the history list form a graph that stores the hierarchical relationship between each change made to a document. At some point in time, an operator may want to merge the contributions associated with one path of the hierarchy with the contributions along another path of the hierarchy. For example, source code in a source control system may have one path that is in the process of being tested for a release while another path contains work on a future version of the product. When the first version is complete, it is often desirable to apply changes containing fixes for any problems found during testing the first version to the future version of the product.

The contribution management system allows check-ins to occur even when the changes made by two editors conflict. If two editors have spent a substantial amount of effort making changes, it may be desirable to allow those changes to be checked in so that they are not lost and then resolve the conflict at a later time. The two editors may also disagree as to which change is correct and want a third editor to be able to view both changes to review each of the changes. The contribution management system will contain complete information about each change, and an operator of the system can select which change should be removed. The operator may also elect to create a branch containing two divergent paths in the history list such that work can continue on each version of the document without affecting the other.

In some embodiments, the contribution management system allows conflict resolution rules to be applied to changes. In the example of source code, the contribution management system can apply rules set up for source code documents, such that when one editor deletes a function that another editor modifies a warning is sent to each of the editors that a conflict exists that needs to be resolved. However, because both changes were allowed to be checked in rather than being rejected or one overwriting the other, the editors or another operator will have complete information about each change with which to resolve the conflict. In some embodiments, the rules may be set up to resolve the conflict automatically. For example, one editor may have seniority over another editor and a rule could be set up such that the senior editor's change prevails when there is a conflict.

In some embodiments, the contribution management system may store milestone versions of the document in the repository. Milestone versions of a document are versions of a document that contain all changes made to the document prior to a particular time. Since the contribution management system stores only the changes made by each editor rather than a complete version of the document, it can become inefficient to compose the current version of the document by applying the individual changes after many changes have been made. Therefore, the contribution management system stores milestone versions of the document at periodic intervals or at times selected by an operator. If the history list contains divergent paths of a document, the contribution management system can maintain milestone versions for each path. The contribution management system uses milestone versions of a document to quickly retrieve versions of a document close to the milestone version. For example, if a version of a document three changes after a milestone version is requested, then the contribution management system retrieves the milestone version and applies the three intervening changes, rather than applying all changes since the document was created.

In some embodiments, the contribution management system uses milestone versions to retrieve versions of a document earlier than a milestone version. For example, if a version of a document three changes prior to a milestone version is requested, then the contribution management system retrieves the milestone version and reverts the three intervening changes to produce the requested version of the document.

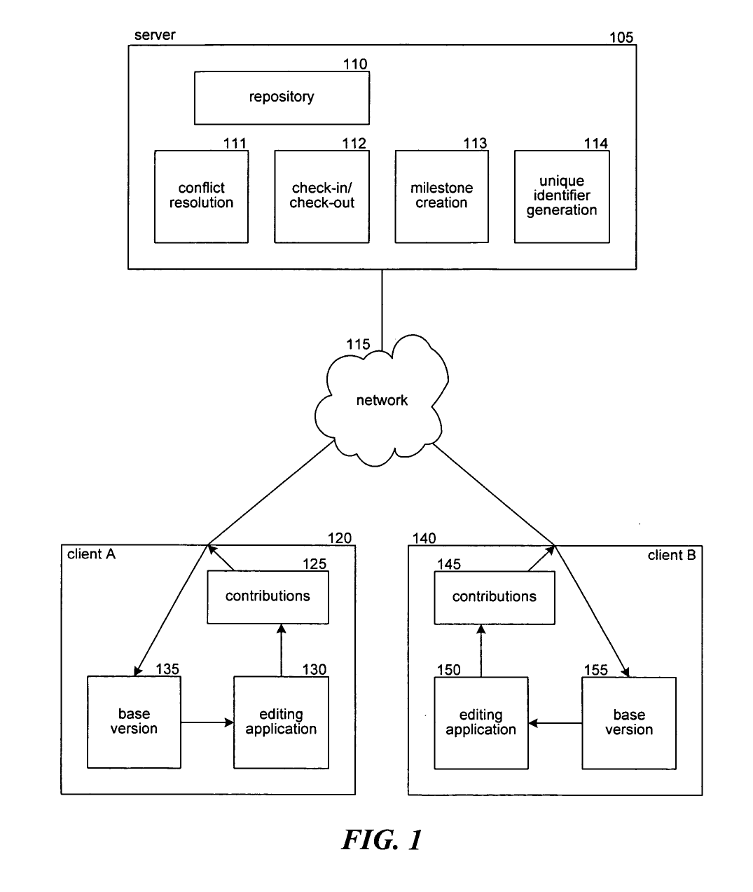

FIG. 1 illustrates a layout of the contribution management system in one embodiment. A server 105 contains a repository 110 that stores all of the changes made to a document, a conflict resolution component 111 that examines changes for conflicts, a check-in/check-out component 112 that services editor requests for files, a milestone creation component 113 that allows an operator to create milestone versions of a document, and a unique identifier generation component 114 that generates unique identifiers for new document elements. The server 105 is connected to a network 115, such as the Internet or a local area network. A client 120 is also connected to the network 115, and contains a base version 135, a contributions component 125, and an editing application 130. The base version 135 is a version retrieved from the server 105 that the editor using the client 120 is modifying. The contributions component 125 creates contributions for each change made by the editor and stores them until they are checked in to the contribution management system. The editing application 130 is used by the editor to make changes to the document stored as contributions by the contributions component 125. In some embodiments, the editing application immediately communicates each contribution to the server and contributions are not stored locally at the client. A second client 140 is also connected to the network 115, and contains a base version 155, editing application 150, and contributions component 145 of an editor using the second client.

The computing device on which the system is implemented may include a central processing unit, memory, input devices (e.g., keyboard and pointing devices), output devices (e.g., display devices), and storage devices (e.g., disk drives). The memory and storage devices are computer-readable media that may contain instructions that implement the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

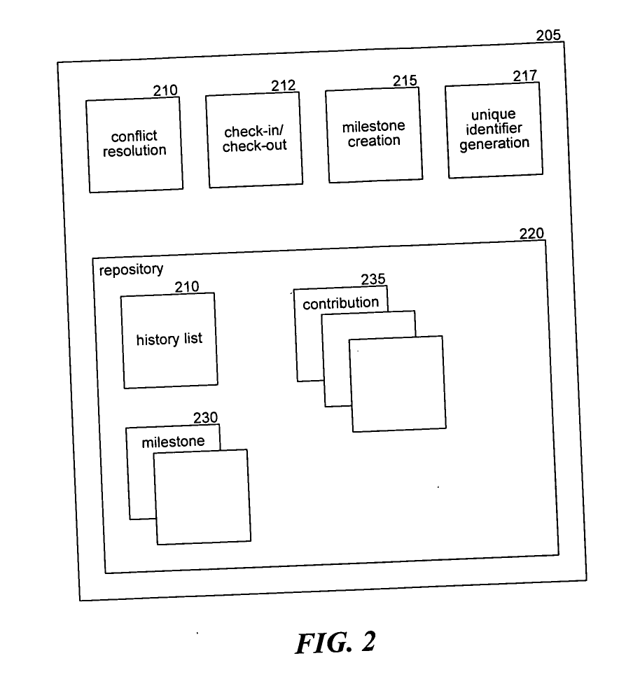

FIG. 2 illustrates components of the contribution management system server in one embodiment. The contribution management system server 205 contains a conflict resolution component 210, a check-in/check-out component 212, a milestone creation component 215, a unique identifier generation component 217, and a repository 220. The conflict resolution component 210 examines checked-in changes for conflicts and performs appropriate steps to resolve the conflict such as applying conflict resolution rules or notifying an operator. The check-in/check-out component 212 allows editors to check in and check out documents and invokes the conflict resolution component for checked in documents. The milestone creation component 215 allows an operator to specify changes to be included in a milestone version of a document so that documents near that version may be quickly retrieved. The unique identifier generation component 217 generates unique identifiers for new document elements contained in changes made by the editors. The repository 220 contains a history list 225, milestone versions of the document 230, and contributions 235 made to the document. The history list 225 stores the relationship between each contribution made to a document. The contributions 235 contain information describing each change made to the document including the operation performed, the unique identifier of the document element that was modified, and other supplemental information such as the editor that made the contribution.

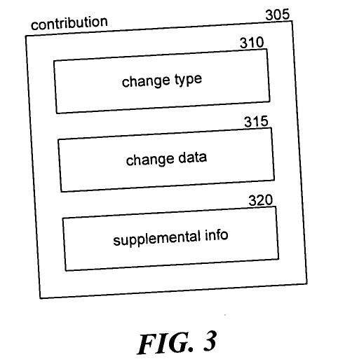

FIG. 3 is a block diagram that illustrates a data structure used by the contribution management system to store contributions in one embodiment. The contribution 305 contains a change type 310, change data 315, and supplemental information 320. The change type 310 stores the type of editing operation that was performed on the identified element. For example, the editing operation can be an add, delete, rename, move, replace, format (e.g., italics), or other type of operation. The change data 315 indicates data specific to the type of change that was performed. For example, a replace operation allows one element to be replaced with another element and the unique identifiers of both elements are specified in the change data. A move operation could specify the previous position and the new position for the element, or could contain the unique identifier of the element that the moved element is positioned after. The supplemental information 320 contains any additional information related to the contribution such as the editor that made the contribution, the time the contribution was made, and so on. In embodiments where each of an editor's contributions made in a single editing session are checked in as a batch at the same time, each contribution may share the same supplemental information.

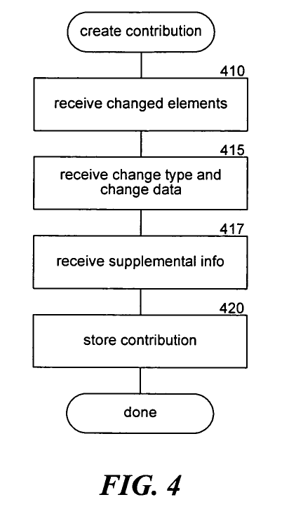

FIG. 4 is a flow diagram that illustrates the processing of the client contributions component in one embodiment. The component is invoked whenever an editor makes a change to the document. In block 410, the component receives the document elements that were modified from an editing application. In some embodiments, the contributions component assigns unique identifiers to any new document elements received. In block 415, the component receives the change type performed on the modified elements and any change data (such as the new position for a move operation). In block 417, the component receives any supplemental information describing the change. In block 420, the component stores a contribution containing the change type, change data, and supplemental information for each change. The component may store each individual contribution by immediately sending it to the server, or the component may batch up contributions for sending to the server in a group. The component may also wait for an instruction by the editor prior to sending contributions to the server.

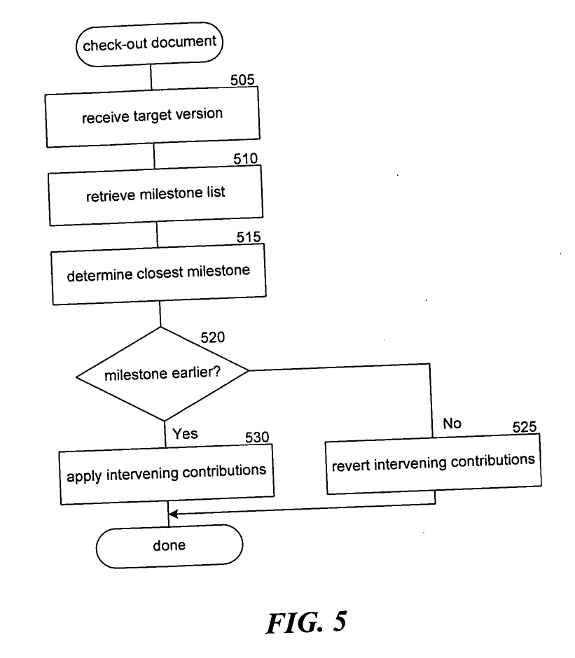

FIG. 5 is a flow diagram that illustrates the processing of the check-out component of the contribution management system server in one embodiment. The component is invoked when an editor attempts to retrieve a particular version of a document. In block 505, the component receives the target version of the document that is to be retrieved from an editor that has selected which changes to have applied. The editor may identify each contribution that is to be applied specifically, or may specify a time indicating that changes prior to that time are to be retrieved. If the history list contains divergent paths of a document, such as for different product versions, the editor may also specify from which path of the document they are interested in retrieving changes, such as by specifying a branch name that has been stored to identify each branch. The editor may also select whether contributions that have been marked as removed due to conflicts should be retrieved, either by choosing these contributions specifically or by indicating with a flag that the editor is interested in all contributions. In block 510, the component retrieves a list of milestone versions that are available in the repository. In block 515, the component determines the closest milestone version. In decision block 520, if the closest milestone version is an earlier version, then the component continues at block 530, else the component continues at block 625. In block 630, the component applies any intervening contributions between the closest milestone version and the target version. In block 525, the component reverts any intervening contributions between the closest milestone version and the target version. The component then returns the requested version of the document and completes.

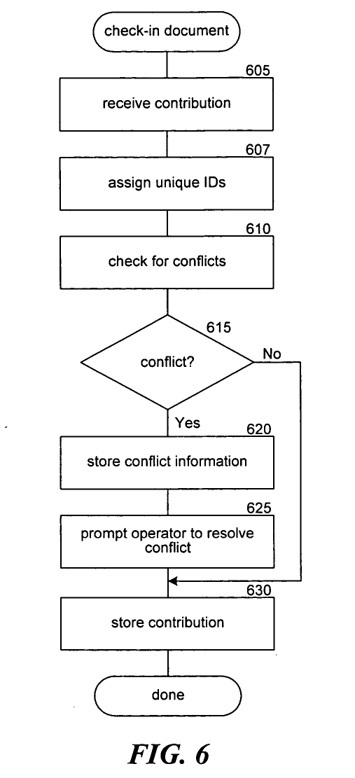

FIG. 6 is a flow diagram that illustrates the processing of the check-in component of the contribution management system in one embodiment. The component is invoked when a new contribution is added to the repository. In block 605, the component receives a new contribution. In block 607, the component assigns a unique identifier to any newly added document element in the contribution. In block 610, the component checks the new contribution for conflicts with previously received contributions. In decision block 615, if the new contribution causes a conflict, then the component continues at block 620, else the component completes. In block 620, the component stores information about the conflict for later use by an operator of the system to resolve the conflict. In block 625, the component prompts an operator of the system to resolve the conflict. The component may prompt the operator in a variety of ways such as by sending an email or displaying a message box on the operator's client computer. In block 630, the component stores the contribution and adds it to the history list. The component then completes.

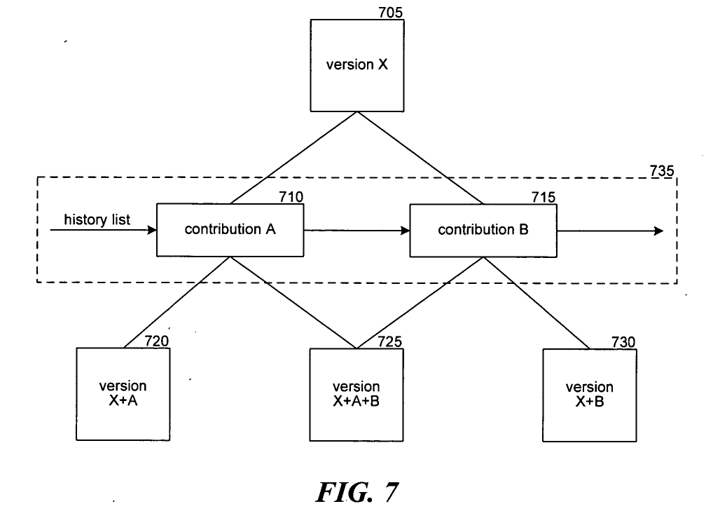

FIG. 7 is a block diagram that illustrates the relationship of versions of a document following two changes to the document. A base version X 705 of the document is modified by contribution A 710 and contribution B 715. Contribution A 710 and contribution B 715 are maintained on the history list 735. Typically, an editor synchronizing with the contribution management system retrieves all contributions to a document that have not been marked as removed by an operator. However, the contribution management system also allows retrieving specific versions of the document containing only change A (version X+A 720), only change B (version X+B 730), or both (version X+A+B 725). This is helpful if the editor is an operator trying to resolve a conflict by examining both changes independently.

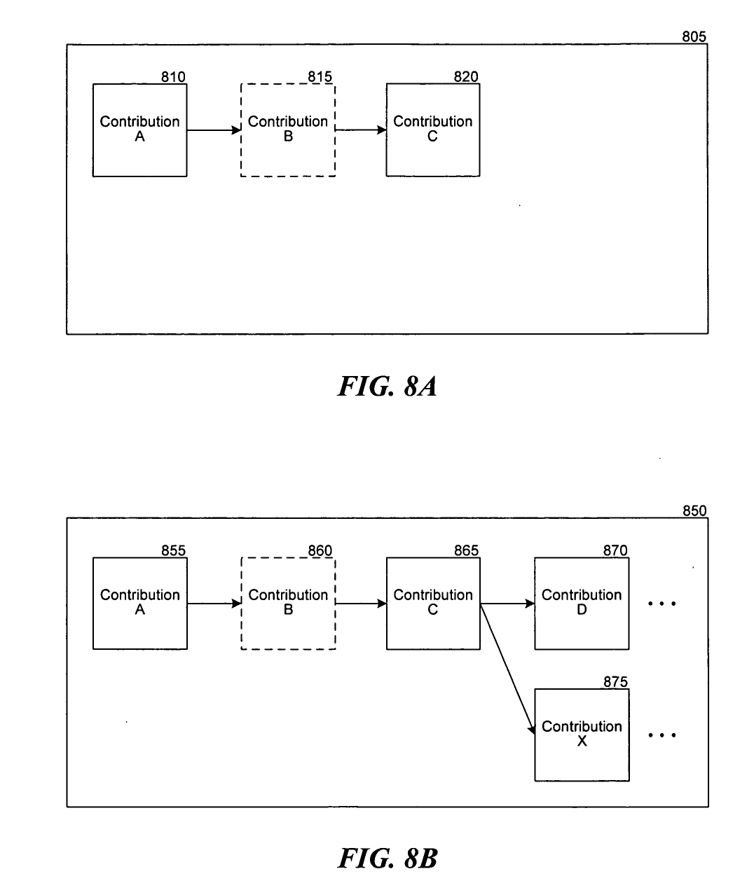

FIGS. 8a and 8b are block diagrams showing the history list in two embodiments. In FIG. 8a, a single list 805 is maintained of contributions that have been made. The list contains contributions A 810, B 815, and C 820. Contribution B 815 is shown with dashed lines indicating that an operator has marked that contribution as being removed due to a conflict or other problem. An editor that requests the most current version of the file specified by this list will receive only contributions A and C, but an editor could specifically request a version of the document with contribution B included. FIG. 8b illustrates a history list 850 where divergent paths of a document have been created. The history list contains contributions A 855, B 860, and C 865 similar to FIG. 8a. The history list also contains a contribution D 870 that follows contribution C 865 in one path of the document and a contribution X 875 that follows contribution C 865 in another path of the document. An editor requesting the most current version of the file can also specify the path of the document that they want to retrieve such as by specifying a branch name identifying the path, or one path may be selected by an operator as the default path if no path is specified.

From the foregoing, it will be appreciated that specific embodiments of the contribution management system have been described herein for purposes of illustration, but that various modifications may be made without deviating from the spirit and scope of the invention. For example, though a software source control system has been used as an example, other document management systems may apply the same techniques such as a publishing system for storing changes to a book where several authors contribute. Accordingly, the invention is not limited except as by the appended claims.

I/we claim:

1. A method in a computer system for representing contributions to a document comprising:
assigning to each element in the document a unique identifier that is persistent;
receiving an editing operation identifying a modified element; and
storing a contribution to the document as the element identifier of the modified element and editing operation performed on the modified element.

2. The method of claim 1 wherein the document contains source code.

3. The method of claim 1 wherein the document is represented as an intentional tree.

4. The method of claim 3 wherein storing a contribution to the document includes applying domain-specific checks to the contribution.

5. The method of claim 3 wherein the document contains text and each character is a uniquely identified element in the document.

6. The method of claim 1 wherein the editing operation is selected from the group consisting of adding an element, removing an element, moving an element, renaming an element, replacing an element, and changing properties of an element.

7. The method of claim 1 wherein the editing operation revives a previously deleted document element.

8. The method of claim 1 including checking the contribution for conflicts with a previously stored contribution.

9. A method in a computer system for restoring a desired version of a document comprising:
retrieving from a repository containing one or more contributions to the document a list of milestones each containing a version of the document with all of the contributions up to that version applied to the document;
determining the closest milestone in the repository to the desired version of the document;
retrieving the determined closest milestone; and
processing the intervening changes between the version of the document at the milestone and the desired version of the document to restore the desired version of the document.

10. The method of claim 9 wherein the document contains source code.

11. The method of claim 9 wherein the closest milestone version contains a contribution subsequent to the desired version and processing the intervening changes includes reverting the contribution made subsequent to the desired version.

12. A method in a computer system for managing conflicts in a source control system comprising:
receiving and storing a first contribution to a document containing source code in the source control system;
receiving a second contribution containing a conflict with the first contribution; and
storing the second contribution in the source control system so that a user can use the source control system to view the first and second contributions and resolve the conflict.

13. The method of claim 12 wherein the document is an intentional tree and the conflict is domain-specific.

14. The method of claim 12 wherein the source control system uses the information received from the user checking in the second contribution to automatically resolve the conflict.

15. A system for document version management comprising:
a unique identifier generation component for generating persistent unique identifiers for new elements in a document;
a contribution describing component for representing changes to elements in a document as contributions containing an identifier for each changed element and an operation type describing the change to each element;
a history list component for storing the order of contributions applied to the document; and
a repository component for storing the history list and each contribution made to the document.

16. The system of claim 15 wherein the document is represented as an intentional tree.

17. One or more computer memories collectively storing a data structure for representing changes to a document comprising:
a change type describing the operation performed on an element;
change data that contains information specific to the change type and the unique identifier of the element that has been changed; and
supplemental information that contains information associated with the change that is not part of the change data.

18. The data structure of claim 17 wherein the change type is a rename operation and the change data contains the old and new name of the identified element.

19. The data structure of claim 17 wherein the change type is a move operation and the change data contains the old and new position of the identified element.

20. The data structure of claim 17 wherein the change type is a delete operation.

21. The data structure of claim 17 wherein the change type is an add operation.

22. The data structure of claim 17 wherein the change type is a formatting change and the change data describes the new formatting applied.
